(19) United States
(12) Patent Application Publication
(10) Pub. No.: US 2009/0063041 A1
(43) Pub. Date: Mar. 5, 2009

(54) NAVIGATION APPARATUS AND NAVIGATION METHOD

(75) Inventors: Naoki HIROSE, Osaka (JP); Kinya OTANI, Osaka (JP); Yuta TAGUCHI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/200,116

(22) Filed: Aug. 28, 2008

(30) Foreign Application Priority Data
Aug. 31, 2007 (JP) 2007-225930

(51) Int. Cl. G01C 21/34; G06F 3/14

(52) U.S. Cl. 701/209; 701/211

(57) ABSTRACT

A navigation apparatus includes map data, a control unit that searches for a route over which a vehicle is to be directed, using the map data, and a display unit that displays an arrow indicating a right turn or a left turn of the vehicle when the vehicle approaches a guide point where the vehicle is directed to turn right or left. The control unit determines the type of a first road which is connected to the guide point and which will be entered after the vehicle turns right or left at the guide point, using the map data. If the first road is a first type of road, the control unit causes the display unit to display the arrow in a first color. If the first road is a second type of road, the control unit causes the display unit to display the arrow in a second color that differs from the first color.

### BACKGROUND OF THE INVENTION

1. Field of the Invention

The present invention relates to a navigation apparatus and a navigation method for guiding a vehicle to a destination along a guidance route by displaying an arrow indicating a right or left turn of the vehicle.

2. Description of the Related Art

A typical vehicle navigation apparatus guides a vehicle along a guidance route by displaying a map of the vicinity of the vehicle's current position, generating audio guidance according to whether the vehicle needs to turn right or left, and further displaying an arrow indicating a right turn or a left turn. Vehicle navigation apparatuses include in-dash navigation apparatuses that have an integrated display unit and main body, and are housed in the dashboard, and on-dash navigation apparatuses that have the display unit set on the dashboard and the main body set under the passenger seat or the like.

In addition to in-dash and on-dash navigation apparatuses, portable navigation apparatuses called Personal Navigation Devices (PND) are currently becoming popular. While the same as an in-dash navigation apparatus in that the display unit and the main body are integrated, a PND uses flash memory as a recording medium for recording map data, is compact, light and slim, and can be removed from the vehicle and carried for use.

Given that when the vehicle is on the move the driver pays constant attention to the situation around the vehicle while driving, attempts have been made with navigation apparatuses to provide the driver with various types of guidance information in a form that can be intuitively recognized. For example, a navigation apparatus disclosed in JP 2000-221048A provides the driver with information related to distance from the vehicle to an intersection through color vision, by changing the color of an arrow indicating a left turn or a right turn at an intersection, according to the distance between the intersection and the vehicle's current position.

With maps displayed by navigation apparatuses, the display colors of the lines indicating the route are differentiated according to the type of road, although it is very dangerous for the driver to study or stare such a map when driving through the complex road network of a city or in congested traffic conditions. Consequently, when turning right or left onto a different type of road from the road currently being traveled along (e.g., vehicle turns off an ordinary road or a local street onto a freeway or an expressway), it is preferable for the driver to be able recognize the type of the road that the vehicle will travel on after turning right or left, without looking at the lines shown on the map. A function such as this would be particularly effective in a PND, given that the display area of the display unit of a PND is small in comparison to the display area of the display unit of an in-dash or on-dash navigation apparatus.

The present invention responds to the aforementioned demands, and has as its object to provide a navigation apparatus and a navigation method that enable the driver to intuitively recognize the type of the road that the vehicle will enter after turning right or left, without reading the map.

### SUMMARY OF THE INVENTION

A navigation apparatus of the present invention includes map data, a control unit that searches for a route over which a vehicle is to be directed, using the map data, and a display unit that displays an arrow indicating a right turn or a left turn of the vehicle when the vehicle approaches a guide point where the vehicle is directed to turn right or left. The control unit determines a type of a first road which is connected to the guide point and which will be entered after the vehicle turns right or left at the guide point, using the map data, and causes the display unit to display the arrow in a first color if the first road is a first type of road, and in a second color that differs from the first color if the first road is a second type of road.

Preferably, with the navigation apparatus of the present invention, the control unit causes the display unit to display an image that includes a map of a vicinity of the vehicle and guidance information that includes the arrow, the image is partitioned into a first portion and a second portion, and the map is disposed in the first portion and the guidance information is disposed in the second portion.

Preferably, with the navigation apparatus of the present invention, the control unit determines whether a second guide point following the guide point is in a prescribed positional relation to the guide point, determines, if the second guide point is in the prescribed positional relation, a type of a second road which is connected to the second guide point and which will be entered after the vehicle turns right or left at the second guide point, using the map data, and causes the display unit to display a second arrow in the first color if the second road is the first type of road, and in the second color if the second road is the second type of road.

A navigation method of the present invention is for guiding a vehicle along a guidance route, and includes specifying a current position of the vehicle, determining, when the vehicle approaches a guide point where the vehicle is directed to turn right or left, a type of a first road which is connected to the guide point and which will be entered after the vehicle turns right or left along the guidance route at the guide point, using map data, and displaying on a display unit an arrow in a first color if the first road is a first type of road, and in a second color that differs from the first color if the first road is a second type of road.

Preferably, the navigation method of the present invention further includes displaying on the display unit an image that includes a map of a vicinity of the vehicle and guidance information that includes the arrow, the image is partitioned into a first portion and a second portion, and the map is disposed in the first portion and the guidance information is disposed in the second portion.

Preferably, the navigation method of the present invention further includes determining whether a second guide point following the guide point is in a prescribed positional relation to the guide point, determining, if the second guide point is in the prescribed positional relation, a type of a second road which is connected to the second guide point and which will be entered after the vehicle turns right or left at the second guide point, using the map data, and displaying on the display unit a second arrow in the first color if the second road is the first type of road, and in the second color if the second road is the second type of road.

With the navigation apparatus and the navigation method of the present invention, the driver is able to intuitively recognize the type of the road that the vehicle will travel on after turning right or left without studying the map, as a result of an arrow indicating a right or left turn being displayed in a color tailored to the type of the road that the vehicle will travel on after turning right or left.

With the navigation apparatus and the navigation method of the present invention, different colors are preferably used for the arrow displayed on the display unit, depending on whether or not the road that the vehicle will travel on after turning right or left is a freeway (or an expressway).

With the navigation apparatus and the navigation method of the present invention, the arrow, in the case where the road that the vehicle will travel on after turning right or left is a freeway, preferably is a color used as a background color or a dominant color in a road sign for a freeway. Alternatively, the arrow preferably is displayed in a color approaching such a color. Moreover, a color other than white preferably is used. Displaying the arrow in a color that puts the driver in mind of a freeway enables the driver to more effectively recognize that the vehicle will be entering a freeway after turning right or left.

### BRIEF DESCRIPTION OF THE DRAWINGS

FIG. 1 is front view of a navigation apparatus constituting an embodiment of the present invention.

FIG. 2 is a block diagram of the navigation apparatus constituting the embodiment of the present invention.

FIG. 3 is a flowchart of a route guidance operation of the navigation apparatus constituting the embodiment of the present invention.

FIG. 4 illustrates an exemplary guidance route.

FIGS. 5A to 5C each show an exemplary screen displayed on the navigation apparatus constituting the embodiment of the present invention when directing a right or left turn.

FIG. 6 shows exemplary road signs used in Japan and the United States.

FIG. 7 shows an exemplary screen displayed on a navigation apparatus constituting a second embodiment of the present invention when directing a right or left turn.

FIG. 8 is a flowchart of a route guidance operation of the navigation apparatus constituting the second embodiment of the present invention.

FIG. 9 is a flowchart of a route guidance operation of the navigation apparatus constituting the second embodiment of the present invention.

### DESCRIPTION OF THE PREFERRED EMBODIMENTS

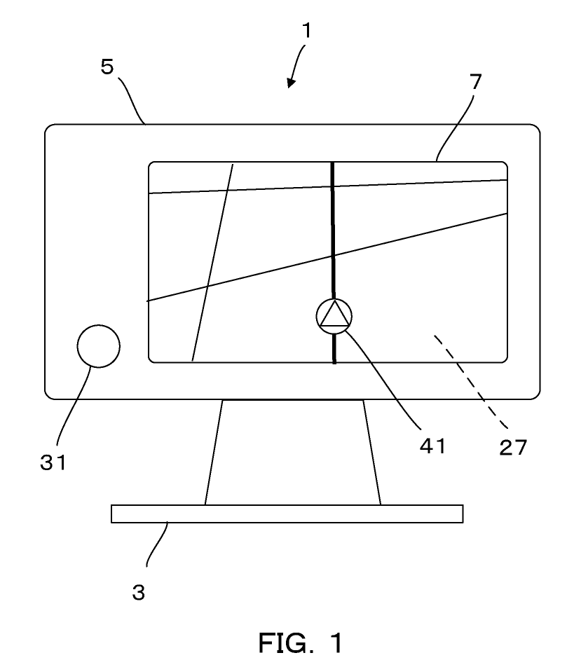

Hereinafter, the present invention will be described using the accompanying drawings. FIG. 1 is front view of a navigation apparatus (1) constituting an embodiment of the present invention. This navigation apparatus (1) is a PND, and, when used in a vehicle, is removably mounted to a mount kit (3) provided on a dashboard of the vehicle. A casing (5) of the navigation apparatus (1) is plate-like in shape and no more than a few centimeter in thickness, and a display unit (7) is set on a front face thereof. The navigation apparatus (1) is driven by a built-in battery when detached from the mount kit (3) and used outside the vehicle, and by a cigarette lighter outlet (a built-in battery may also be used) when used in the vehicle. The following description assumes that the navigation apparatus (1) is mounted to the mount kit (3) and used for driving guidance.

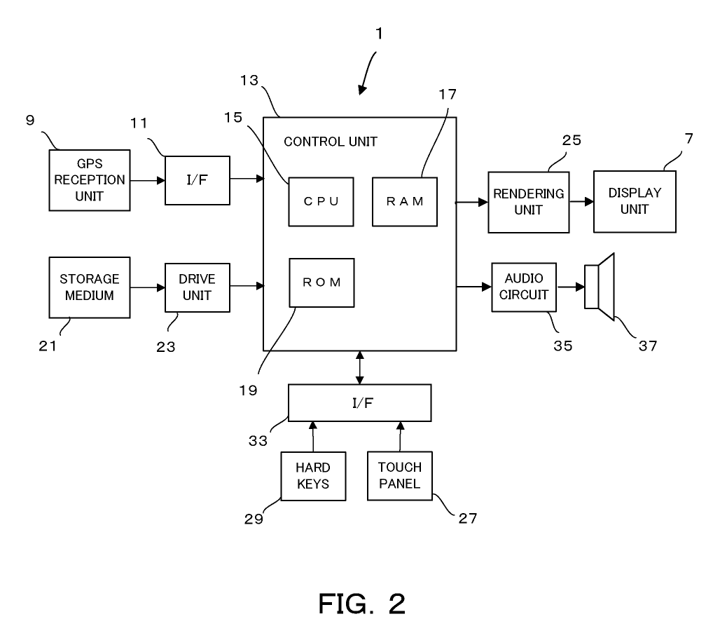

FIG. 2 is a block diagram showing the configuration of the navigation apparatus (1) of the present embodiment. A GPS reception unit (9), which is constituted by an internal receiving antenna, a tuner and the like, processes radio waves received from GPS satellites and retrieves positioning data. The retrieved positioning data is sent to a control unit (13) via an interface (11). The control unit (13) specifies the vehicle's current position based on the positioning data sent from the GPS reception unit (9). The navigation apparatus (1) does not have a vehicle speed sensor, a gyro sensor or the like, so the control unit (13) specifies the speed and direction of travel of the vehicle based on the positioning data sent from the GPS reception unit (9). The navigation apparatus (1) is configured so that a vehicle speed sensor, a gyro sensor or the like can be connected, and these may be used to specify the speed and direction of travel of the vehicle.

The control unit (13) executes various operations and processing such as specifying vehicle position and searching for routes, together with performing overall control of the navigation apparatus. The control unit (13) includes a CPU (15) that is constituted by a microcomputer, for example, and executes various computer programs describing procedures for operations and processing, a RAM (17) that temporarily stores data used by the CPU (15) and programs executed by the CPU (15), and a ROM (19) that stores font data, programs describing basic controls related to startup and input/output, and the like.

A recording medium (21) stores map data including information required for map display, route searching, route guidance and the like, rendering parameters stipulating the colors and shapes of directional arrows, the thickness and color of lines indicating roads, and the like, a database for destination searching, and computer programs describing the operations and processing of the navigation apparatus (1). A memory card using flash memory, a hard disk, a DVD, a CD-ROM or the like may be used for the recording medium (21). The control unit (13) reads out and executes programs stored in the recording medium (21), via a drive unit (23).

Map data includes road data that is used in route searching and route guidance and describes road networks, background data that is used in map display and describes the course of roads, rivers and the like included in a map, and character/symbol data that is used for displaying the names of administrative units such as states, prefectures and municipalities, road names, map symbols and the like. The map data is configured in prescribed rectangular areas, and the control unit (13) appropriately reads out and uses map data required for the range required in an operation or processing.

Nodes are defined in correspondence to points on roads. For each node, road data includes an ID number, a latitude, a longitude, ID numbers of links connected to the node, and the type of the node. Simple node, intersection, fork in a road, dead end, and the like are designated as types of nodes. A link is defined by two adjacent nodes along a road. Road data includes, for each link, an ID number, ID numbers of its start and end nodes, a road type, a road name, and a link length. For example, freeway, expressway, public highway, national highway, state highway, local street and the like are designated as road types. Link length is a length of the interval or leg of a road corresponding to a link.

A rendering unit (25) is an IC chip that includes a dedicated rendering CPU or the like, and creates map image data and operation screen image data based on instructions from the control unit (13). The display unit (7) displays an image in a display area, based on image data created by the rendering unit (25). A liquid crystal display device, for example, is used for the display unit (7).

The navigation apparatus is provided with a touch panel (27) and hard keys (29) as operation means. The hard keys (29) includes a power key (31) (see FIG. 1) for turning power on/off, and other keys provided on a lateral face of the casing (5). When the touch panel (27) or one of the hard keys (29) is pressed, a signal notifying the pressing thereof is sent to the control unit (13) via an interface (33). The touch panel (27) is a pressure-sensitive touch panel with transparent electrodes arranged in a grid, for example, and is set on the display area of the display unit (7) (see FIG. 1).

An audio circuit (35) generates an analog audio signal related to a voice for route guidance or the like, based on audio data sent from the control unit (13). The generated analog audio signal is reproduced by a speaker (37).

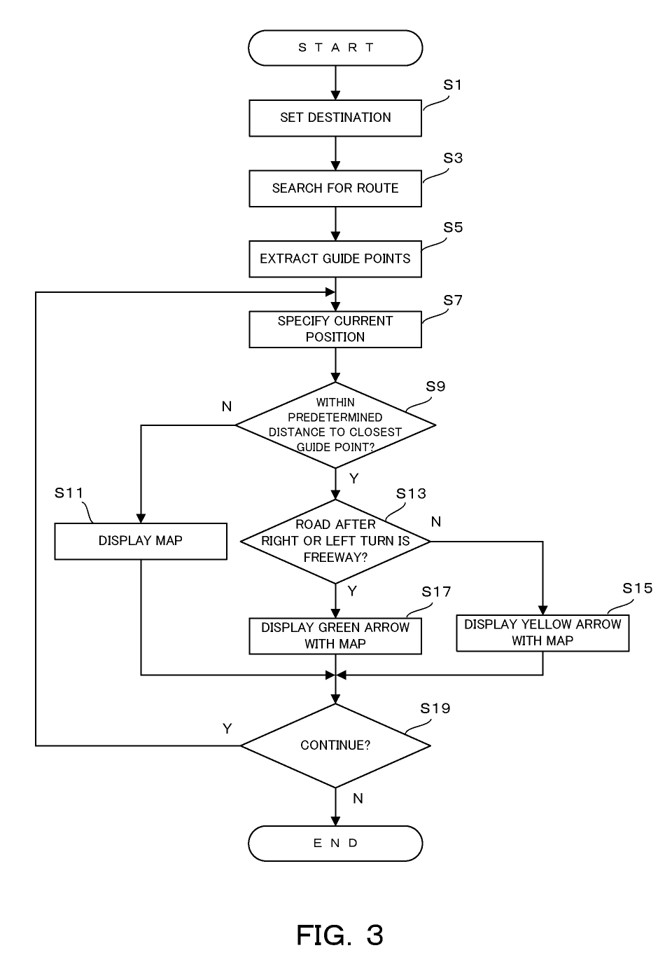

FIG. 3 is a flowchart showing a route guidance operation of the navigation apparatus (1). The route guidance operation is realized as a result of a program describing this operation being executed by the CPU (15) of the control unit (13). The route guidance operation starts as a result of a driver (or passenger) instructing execution via the touch panel (27), with a menu screen (not shown) displayed on the display unit (7), for example.

With the route guidance operation, firstly, a destination is set by the driver (S1). Specifically, a search screen (not shown) for searching for a destination desired by the driver is displayed on the display unit (7) as a result of the control unit (13) instructing the rendering unit (25), and the driver designates search criteria via the touch panel (27). There is a plurality of types of search screens, with a search screen for searching for a place such as a facility or a store based on a telephone number and a search screen for searching for a place based on a name, for example, being selectively displayed. The control unit (13) searches the database stored in the recording medium (21) based on the designated search criteria, and specifies a place (or places) that matches the criteria. The driver instructs, via the touch panel (27), that the specified place (or one of the specified places) be set as the destination.

Following step S1, a route search for searching for a guidance route to the destination is executed by the control unit (13) (S3). Firstly, a setting screen (not shown) for the driver to set search criteria is displayed on the display unit (7) as a result of the control unit (13) instructing the rendering unit (25). The driver designates search criteria (cost) via the touch panel (27). Search criteria include time, distance and the like. Next, the control unit (13) specifies the vehicle's current position, which is the starting point, based on the positioning data obtained from the GPS reception unit (9). The control unit (13) then reads out and stores in the RAM (17) road data for a prescribed range that includes the starting point and the destination, and searches for a guidance route based on Dijkstra's algorithm, for example. At this time, the nodes closest to the destination and the starting point, for example, are respectively set as the goal point node (or destination node) and the starting point node. If time is designated as a search criterion, a route search is performed to search for a guidance route with the shortest travel time to the destination, and if distance is designated, a route search is performed to search for a guidance route with the shortest distance to the destination. Information on the guidance route specified by the route search, that is, information on the nodes and links constituting the guidance route is stored in the RAM (17).

Following step S3, processing to extract guide points is performed by the control unit (13) (S5). A guide point is an intersection or a fork in a road on the guidance route that requires the vehicle to turn right or left. The control unit (13) extracts nodes (hereinafter, guide point nodes) on the guidance route that correspond to such intersections or forks from the nodes constituting the guidance route, and stores the extracted guide point nodes in the RAM (17) with the sequence (order from the current position to the destination) of the respective guide point nodes associated therewith.

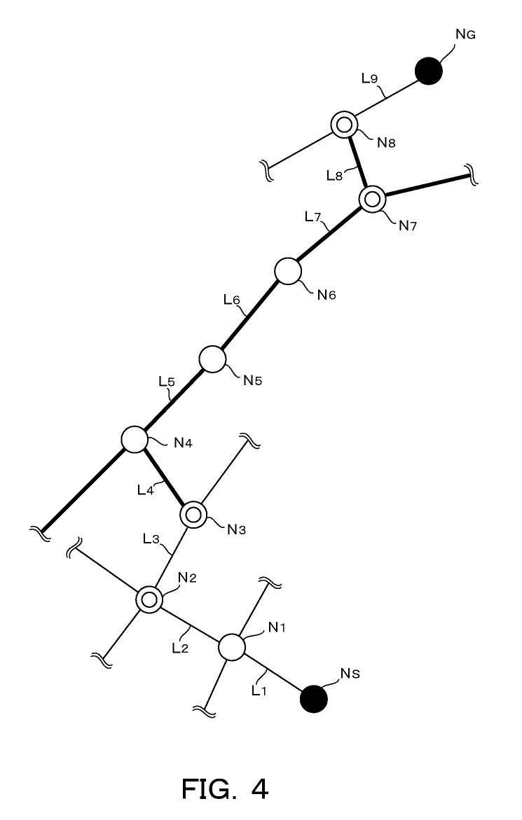

FIG. 4 illustrates an exemplary guidance route. At step S3 shown in FIG. 3, a route search is performed, and a guidance route from a starting point node N_{S} to a goal point node N_{G} is derived. The guidance route includes the starting point node N_{S}, the goal point node N_{G}, and nodes N₁ to N₈ between the starting point node N_{S} and the goal point node N_{G}, with these nodes being connected by links L₁ to L₉. In FIG. 4, the links shown by the thin lines indicate a road other than a freeway (or an expressway), while the links shown by the thick lines indicate a freeway. In FIG. 4, guide point nodes where the vehicle needs to be directed to make a right turn or a left turn are indicated with double circles. At step S5, nodes N₂, N₃, N₇ and N₈ are extracted as guide point nodes (nodes N₄ is a node corresponding to a junction point or a merging point).

Following step S5, the control unit (13) specifies the vehicle's current position, based on positioning data obtained from the GPS reception unit (9) (S7). The control unit (13) then determines whether the vehicle has approached within a predetermined distance (distance along the guidance route) to the closest guide point that the vehicle will subsequently pass through (S9). At step S9, the distance from the vehicle's current position specified at step S7 to the closest guide point that the vehicle will subsequently pass through out of the guide points extracted at step S5 is derived based on the latitude and longitude of the guide point node and link lengths, and it is determined whether that distance is within the predetermined distance.

If, at step S9, it is determined that the vehicle has not approached within the predetermined distance to the closest guide point, the control unit (13) performs processing to display a map of the vicinity of the vehicle's current position on the display unit (7) (S11). The control unit (13) reads out background data and character/symbol data for a prescribed range that includes the vehicle's current position, and instructs the rendering unit (25) to render a map on which the vehicle's current position is indicated. The rendering unit (25) creates image data for a map based on the read data, and the display unit (7) displays a map based on the image data. For example, a map on which the vehicle's current position is indicated with a symbol (41) as in FIG. 1 is shown over the entire display area of the display unit (7).

If, at step S9, it is determined that the vehicle has approached within the predetermined distance to the closest guide point, the control unit (13) determines whether the type of the road which is connected to that guide point and which will be entered (or traveled along) after the vehicle turns right or left is a freeway (S13). As aforementioned, the types of road related to the links constituting the guidance route are included in the guidance route information. The control unit (13) performs the determination of step S13 with reference to the type of road related to the link, being one of the links included in the guidance route, that begins (on the starting point side) at the guide point node corresponding to the closest guide point.

If, at step S13, it is determined that the type of the road entered after the vehicle turns right or left is not a freeway, the control unit (13) performs processing to display on the display unit (7) a yellow arrow indicating a right or left turn, together with a map of the vicinity of the vehicle's current position (S15). The control unit (13) reads out background data and character/symbol data for a prescribed range that includes the vehicle's current position, and instructs the rendering unit (25) to render a map on which the vehicle position is indicated. The rendering unit (25).creates image data for a screen that includes a map and a yellow arrow, based on the read data and the rendering parameters, and the display unit (7) displays a screen that includes a map and a yellow arrow, based on the image data. The yellow arrow represents the fact that the road which the vehicle will enter after turning right or left is a road other than a freeway (for example, an ordinary road or a local street), together with the fact the vehicle will need to be steered right or left.

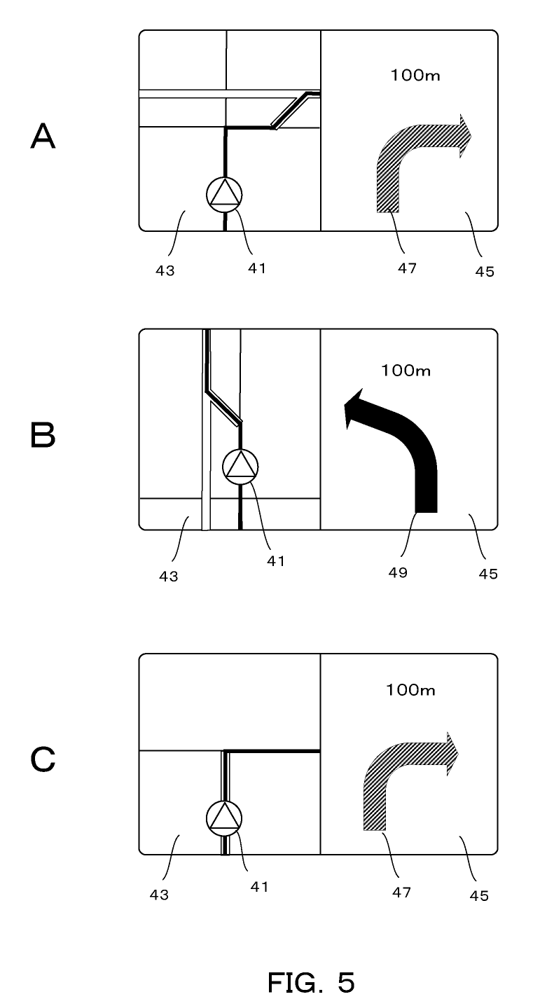

In the FIG. 4 example, it is determined at step S9 that the vehicle's current position is within the predetermined distance to the guide point corresponding to the guide point node N₂. Then, at step S13, it is determined, with reference to the road type of the link L₃ which begins at the guide point node N₂, that the road which the vehicle will enter after turning right is not a freeway. Further, step S15 is executed, and a screen such as shown in FIG. 5A is displayed on the display unit (7). A map indicating the vehicle's current position is displayed in a portion (43) on the left half of the screen, and guidance information including a yellow arrow (47) and the distance to the intersection or fork in the road is shown in a portion (45) on the right half of the screen.

If, at step 9, it is determined that the vehicle's current position is within the predetermined distance to the guide point corresponding to the guide point node N₈, it is determined at step S13, with reference to the road type of the link L₉ which begins at the guide point node N₈, that the road which the vehicle will enter after turning right is a road other than a freeway. Then, step S15 is executed, and a screen that includes the yellow arrow (47) as shown in FIG. 5C is displayed on the display unit (7).

If, at step S13, it is determined that the road which the vehicle will enter after turning right or left is a freeway, the control unit (13) performs processing to display on the display unit (7) a green arrow indicating that the vehicle needs to be steered right or left, together with a map of the vicinity of the vehicle's current position (S17). The control unit (13) reads out background data and character/symbol data for a prescribed range that includes the vehicle's current position, and instructs the rendering unit (25) to render a map on which the vehicle position is indicated. The rendering unit (25) creates image data for a screen that includes a map and a green arrow, based on the read data and the rendering parameters, and the display unit (7) displays a screen that includes a map and a green arrow, based on the image data. The green arrow represents the fact that the road which the vehicle will enter after turning right or left is a freeway, together with the fact the vehicle will need to be steered right or left.

If, at step S9, it is determined that the vehicle is within the predetermined distance from the guide point corresponding to the guide point node N₃ shown in FIG. 4, it is determined at step S13, with reference to the road type of the link L₄ which begins at the guide point node N₃, that the road which the vehicle will enter after turning left is a freeway. Then, step S17 is executed, and a screen such as shown in FIG. 5B is displayed on the display unit (7). A map of the vicinity of the vehicle's current position is displayed in the portion (43) on the left half of the screen, and guidance information including a green arrow (49) and the distance to the intersection or fork in the road is shown in the portion (45) on the right half of the screen.

At steps S15 and S17, audio or voice guidance for a right or left turn is also performed. Following steps S11, S15 or S17, the control unit (13) determines whether to continue the route guidance operation (S19), and if it is determined to continue, the processing from step S7 onwards is again executed. If an operation end instruction is given by the driver, the control unit (13) ends the route guidance operation.

As shown in FIGS. 5A to 5C, when directing a right or left turn with the navigation apparatus (1) of the present embodiment, half of the screen displayed on the display unit (7) is used for displaying guidance information for the right or left turn. With the navigation apparatus (1) of the present embodiment, the arrows (47) and (49) indicating a right or left turn are thus displayed at a relatively large size, compared to a typical navigation apparatus. As a result of such a process or such an operation being performed, the guidance information including the arrows (47) and (49) is shown at a large enough size to be recognizable without the driver staring at the screen while the navigation apparatus (1) of the present embodiment is a PND and the display size of the display unit (7) is relatively small.

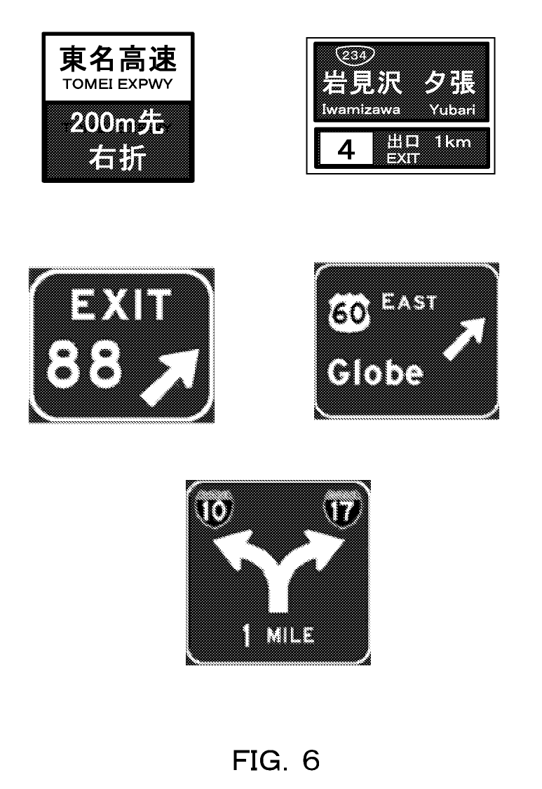

With the navigation apparatus (1) of the present embodiment, green is used as the color of the arrow indicating a right or left turn in the case where the type of the road that the vehicle will enter after turning right or left is a freeway. In Japan, road signs for a freeway (or an expressway) are designed with green as the base color. In FIG. 6, exemplary road signs used for freeway in Japan are shown. With these road signs, the background color or dominant color is green, and white is used for many of characters and symbols. Hence, if someone driving in Japan sees a road sign whose background color is green or whose dominant color is green, the driver will naturally recognize that road sign as being associated with a freeway. By focusing on this point, the navigation apparatus (1) of the present embodiment is, in the case where the type of the road that the vehicle will enter after turning right or left is a freeway, able to intuitively convey to the driver the fact that the vehicle will be entering a freeway by using green as the color of the arrow.

Even in countries such as the United States and China, road signs related to freeways have designs whose base color is green. In FIG. 6, exemplary road signs used for freeways in the United States are also shown. Similarly to Japan, road signs for freeways in the United States also have green as a background color or a dominant color, and white characters and symbols. Hence, even in countries such as the United States and China, the navigation apparatus (1) of the present embodiment is able to intuitively convey to the driver the fact that the vehicle will be entering a freeway.

In Europe, road signs related to freeways are designed with blue as the base color. Hence, if the navigation apparatus (1) of the present embodiment were to be used in Europe, blue would likely be the preferable color of the arrow displayed when the type of the road that the vehicle will enter after turning right or left is a freeway. Note that using white as the color of the arrow displayed when entering a freeway is not considered very desirable given that the driver is not put in mind of a freeway.

With the navigation apparatus (1) of the present embodiment, the color of the arrow in the case where the type of the road that the vehicle will enter after turning right or left is not a freeway is yellow rather than green. This enables the fact that the vehicle will arrive at the interchange exit of a freeway or the like and enter an ordinary road or a local street, for example, after leaving the freeway to be intuitively conveyed to the driver. Given that, in Japan, road signs related to a road other than a freeway are generally designed with blue as the base color, the color of the arrow in this case should probably be blue.

In the present invention, the arrows need not be displayed in exactly the same colors as those used as background colors or dominant colors in road signs. The arrows need merely be displayed in colors that approach colors used as background colors or dominant colors in road signs. It should be readily evident that the effect of the present invention will be obtained even if the colors of the arrows are not precisely the same as the colors of road signs.

A navigation apparatus of a second embodiment has a substantially similar configuration to the navigation apparatus (1) shown in FIGS. 1 and 2. However, in the case where a guide point that the vehicle will pass through following the closest guide point that the vehicle will pass through is in a prescribed positional relation to the closest guide point, such as where these guide points are in proximity to one another, for example, the navigation apparatus of the second embodiment also displays an arrow related to the following guide point in addition to an arrow related to the closest guide point.

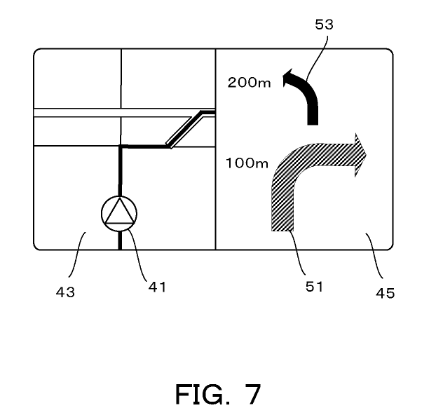

FIG. 7 shows an exemplary screen displayed on the navigation apparatus constituting the second embodiment of the present invention when directing a right turn or a left turn. In FIG. 7, the screen displayed when the vehicle enters within a predetermined distance to a guide point corresponding to the guide point node N₂ in FIG. 4 is shown. A green arrow (53) indicating a left turn at the guide point corresponding to the guide point node N₃, which is in proximity to the guide point corresponding to the guide point node N₂, is also shown, above a yellow arrow (51) indicating a right turn at the guide point corresponding to the guide point node N₂. The arrow (53) directing a left turn following the right turn directed by the arrow (51) is smaller than the arrow (51). Which of the arrow (51) and the arrow (53) shows the right or left turn that is to be initially made is thus clearly indicated.

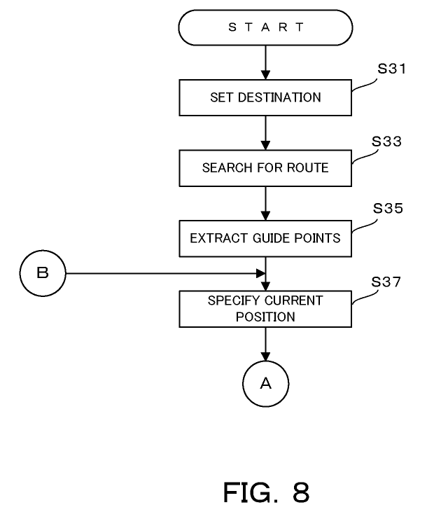

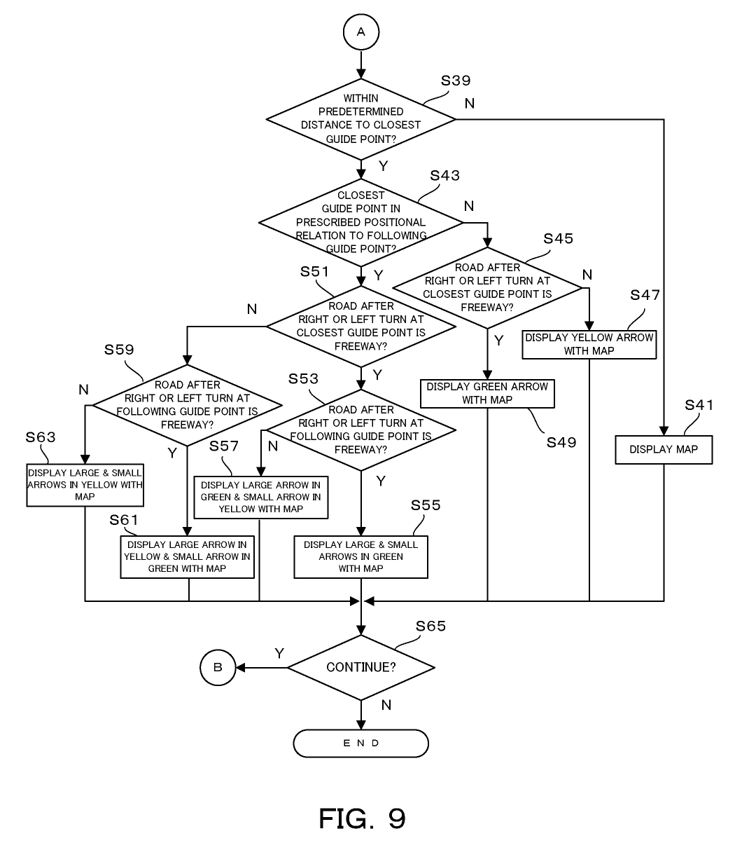

FIGS. 8 and 9 are flowcharts showing a route guidance operation of the navigation apparatus of the second embodiment. Steps S31 to S41 are similar to steps S1 to S11 shown in FIG. 3. If, at step S39, it is determined that the vehicle's current position is within a predetermined distance to the closest guide point, the control unit (13) determines whether a guide point that the vehicle will pass through following the closest guide point is in a prescribed positional relation to the closest guide point (S43).

At step S43, whether the following guide point is in proximity to the closest guide point is determined based on length(s) of the link(s) connecting the two guide point nodes corresponding to these guide points. If the distance (along the guidance route) between the closest guide point and the following guide point is at or below a prescribed length, these guide points will be judged to be in proximity to one another. If, at step S43, it is determined that the closest guide point and the following guide point are not in the prescribed positional relation, steps S45 to S49 corresponding respectively to steps S13 to S17 shown in FIG. 3 are performed.

If, at step S43, it is determined that the closest guide point and the following guide point are in the prescribed positional relation, the control unit (13), similarly to step S45 (i.e., step S13), determines whether the type of the road which is connected to the closest guide point and which the vehicle will enter (or travel along) after turning right or left at the closest guide point is a freeway (S51). If, at step S51, it is determined that the road which the vehicle will enter is a freeway, the control unit (13) determines whether the type of the road which is connected to the following guide point and which the vehicle will enter after turning right or left at the following guide point is a freeway (S53). The control unit (13) performs the determination of step S53 with reference to the road type of the link, being one of the links included in the guidance route, that begins at the guide point node corresponding to the following guide point.

If, at step S53, it is determined that the vehicle will enter a freeway, the control unit (13) performs processing to display both a large arrow related to the closest guide point and a small arrow related to the following guide point in green on the display unit (7), together with a map of the vicinity of the vehicle's current position (S55). If, at step S53, it is determined that the vehicle will not enter a freeway, the control unit (13) performs processing to display a large arrow related to the closest guide point in green and a small arrow related to the following guide point in yellow on the display unit (7), together with a map of the vicinity of the vehicle's current position (S57).

If, at step S51, it is determined that the vehicle will not enter a freeway, the control unit (13) performs similar processing to step S53 (S59). If, at step S59, it is determined that the vehicle will enter a freeway, the control unit (13) performs processing to display a large arrow related to the closest guide point in yellow and a small arrow related to the following guide point in green on the display unit (7), together with a map of the vicinity of the vehicle's current position (S61). If, at step S59, it is determined that the vehicle will not enter a freeway, the control unit (13) performs processing to display both a large arrow related to the closest guide point and a small arrow related to the following guide point in yellow on the display unit (7) (S63). Step S65, which is similar to step S19 shown in FIG. 3, is executed following step S41, S47, S49, S55, S57, S61 or S63.

While the present invention has been described above using a PND, that is, a portable navigation apparatus as an example, the operation and effect of the present invention will clearly be achieved even if the present invention is applied to an in-dash or on-dash navigation apparatus. In the present invention, the color of the arrow directing a right or left turn may be the display color employed on a map for the road along which the vehicle will travel after turning right or left at a guide point. For example, assuming that on a map that the navigation apparatus displays on the display unit, red is used for lines indicating an interstate highway, orange is used for lines indicating a national highway, and yellow is used for lines indicating a state highway, a red arrow, an orange arrow and a yellow arrow may be displayed in order to direct a right or left turn in the case where the type of the road that the vehicle will enter after turning right or left at a guide point is, respectively, an interstate highway, a national highway and a state highway.

The description of the foregoing embodiments is intended to illustrate the present invention, and should not be construed as limiting the invention as set forth in the claims or restricting the scope thereof. Further, the specific configurations of the present invention are not limited to the foregoing embodiments, and various modifications can, of course, be implemented within the technical scope of the invention as set forth in the claims.

What is claimed is:

1. A navigation apparatus comprising:
map data;
a control unit that searches for a route over which a vehicle is to be directed, using the map data; and
a display unit that displays an arrow indicating a right turn or a left turn of the vehicle when the vehicle approaches a guide point where the vehicle is directed to turn right or left,
wherein the control unit determines a type of a first road which is connected to the guide point and which will be entered after the vehicle turns right or left at the guide point, using the map data, causes the display unit to display the arrow in a first color if the first road is a first type of road, and causes the display unit to display the arrow in a second color that differs from the first color if the first road is a second type of road.

2. The navigation apparatus according to claim 1,
wherein the control unit causes the display unit to display an image that includes a map of a vicinity of the vehicle and guidance information that includes the arrow,
the image is partitioned into a first portion and a second portion, and
the map is disposed in the first portion and the guidance information is disposed in the second portion.

3. The navigation apparatus according to claim 1, wherein the control unit determines whether a second guide point following the guide point is in a prescribed positional relation to the guide point, determines, if the second guide point is in the prescribed positional relation, a type of a second road which is connected to the second guide point and which will be entered after the vehicle turns right or left at the second guide point, using the map data, causes the display unit to display a second arrow in the first color if the second road is the first type of road, and causes the display unit to display the second arrow in the second color if the second road is the second type of road.

4. The navigation apparatus according to claim 3, wherein the second arrow is smaller than the arrow.

5. The navigation apparatus according to claim 1, wherein the first type of road is a freeway and the second type of road is a road other than a freeway.

6. The navigation apparatus according to claim 5, wherein the first color is a color other than white, and is a color used as a background color or a dominant color in a road sign for a freeway, or a color approaching such a color.

7. A navigation method for guiding a vehicle along a guidance route, comprising:
specifying a current position of the vehicle;
determining, when the vehicle approaches a guide point where the vehicle is directed to turn right or left, a type of a first road which is connected to the guide point and which will be entered after the vehicle turns right or left along the guidance route at the guide point, using map data; and
displaying on a display unit an arrow in a first color if the first road is a first type of road, and displaying on the display unit the arrow in a second color that differs from the first color if the first road is a second type of road.

8. The navigation method according to claim 7, further comprising displaying on the display unit an image that includes a map of a vicinity of the vehicle and guidance information that includes the arrow, wherein
the image is partitioned into a first portion and a second portion, and
the map is disposed in the first portion and the guidance information is disposed in the second portion.

9. The navigation method according to claim 7, further comprising:
determining whether a second guide point following the guide point is in a prescribed positional relation to the guide point;
determining, if the second guide point is in the prescribed positional relation, a type of a second road which is connected to the second guide point and which will be entered after the vehicle turns right or left at the second guide point, using the map data; and
displaying on the display unit a second arrow in the first color if the second road is the first type of road, and displaying on the display unit the second arrow in the second color if the second road is the second type of road.

10. The navigation method according to claim 9, wherein the second arrow is smaller than the arrow.

11. The navigation method according to claim 7, wherein the first type of road is a freeway and the second type of road is a road other than a freeway.

12. The navigation method according to claim 11, wherein the first color is a color other than white, and is a color used as a background color or a dominant color in a road sign for a freeway, or a color approaching such a color.
